(19) United States
(12) Patent Application Publication
(10) Pub. No.: US 2010/0296638 A1
(43) Pub. Date: Nov. 25, 2010

(54) COMMUNICATION DEVICE WITH AUTOMATIC RESPONDING FUNCTION AND AUTOMATIC RESPONDING METHOD THEREOF

(75) Inventor: Xiao-Bing Wang, Nanjing (CN)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/783,822

(22) Filed: May 20, 2010

(30) Foreign Application Priority Data
May 20, 2009 (TW) 98116702

(51) Int. Cl. H04M 1/64

(52) U.S. Cl. 379/88.04

(57) ABSTRACT

A communication device with a voice automatic responding function, which stores a phone number and response data inputted by an input module as an automatic responding data is illustrated in an exemplary embodiment of the present disclosure. When the user executes the automatic responding unit, the communication device dials the phone number to communicate with a voice service system server. After the call is connected, the communication device sequentially sends each of the response codes after an interval, thus automatically completing the voice responding process.

### CROSS-REFERENCE TO RELATED APPLICATION

This application claims the priority benefit of Taiwan application serial no. 98116702, filed on May 20, 2009. The entirety of the above-mentioned patent application is hereby incorporated by reference herein and made a part of specification.

### BACKGROUND OF THE INVENTION

1. Technical Field

The exemplary embodiments of the present invention relate to a communication device, and more particularly, to a communication device with a voice automatic responding function.

2. Description of Related Art

Nowadays, when a company, organization, or governmental agency is called, the call is often answered by an interactive voice response (IVR) system provided by the organization. After the call is answered by the IVR system, the IVR system first plays voice response which states multiple function selection items and asks the user to select. The user may press the key associated with the desired function according to the voice response.

For example, when a user calls a bank, the IVR system sequentially states “press 1 for account inquiry, press 2 for transfer, press 3 for credit card matters, press 9 for taking to one of our representatives”. If a user wants to consult about credit card matters, he or she has to listen to the pre-recorded voice statements about other options before listening to a voice statement about credit card matters and knowing that he or she needs to press the key “3” for credit card matters. Suppose the user often asks this bank credit card related questions, he or she may directly press the key “3” soon after the call is answered by the voice response system, thus saving time. However, when the user presses key “3”, a plurality of items needs to be selected and there are multiple levels of function items thereafter. It would be difficult for the user to memorize these complex items. On the other hand, listening to the whole voice response or statements also wastes a lot of time. In particular, to a user of the mobile phone, after listening to the voice response, he or she needs to move the mobile phone away from the ear to see the keys on the mobile phone. After pressing a key, the user needs to move the mobile phone back to be adjacent to the ear to continue to listen to the voice response.

To this end, a user's manual of the voice response system is conventionally distributed to the user or published on a website. However, each time the user makes a call, he or she still has to look for the desired selecting process from hundreds of items.

In addition, when using the bank or ticket booking IVR system, the user is often asked to input information such as the account number, card number, or ID number. These complex numbers need to be inputted by the user, making the conventional IVR system inconvenient to use.

### SUMMARY

Accordingly, exemplary embodiments of the present invention are directed to a communication device with a voice automatic responding function which automatically completes the voice response process by using phone numbers and response data that are inputted in advance.

An exemplary embodiment of the present invention provides a communication device with a voice automatic responding function for communicating with an IVR system. The communication device comprises a response setting unit, a data storage unit, and an automatic responding unit.

The response setting unit is used to set an automatic responding data. The automatic responding data contains a phone number, an interval data, and response data.

The data storage unit is used to store the automatic responding data. The automatic responding unit is used to sequentially dial the phone number in the automatic responding data and, after the call is answered by the IVR system, the automatic responding unit is used to respond to the IVR system with the response data.

An exemplary embodiment of the present invention further provides a voice service automatic responding method comprising: (a) setting an automatic responding data containing a phone number, response data, and interval data; (b) storing the automatic responding data in the communication device; (c) selecting the automatic responding data and determining whether the automatic responding data is to be used in a manual responding mode or an automatic responding mode.

The voice service automatic responding method further comprises: (d) if the automatic responding data is in the manual responding mode, the user dials the phone number in the automatic responding data and, after the call is answered, the user needs to press a response sending object in order to send the response data. If the automatic responding data is in the automatic responding mode, the phone number in the automatic responding data is automatically dialled and, after the call is answered, the response data is sequentially sent after the interval.

Therefore, the communication device with a voice automatic responding function permits the user to store the automatic responding data in advance and automatically performs the selecting process of the IVR system in a general dialling manner to directly reach the desired function which the user wants to use. Therefore, the user does not need to spend time in undergoing the whole voice process, or memorize the complex items, and/or look up in the user's manual at each time of calling for the voice service as usual, thus facilitating the use of the voice service. If the communication device is a mobile phone, it is not required as usual to move the mobile phone away from the ear to select desired keys, which also facilitates the use of the voice service.

Other objectives, features and advantages of the communication device with a voice automatic responding function and the automatic responding method thereof will be further understood from the further technological features disclosed by the exemplary embodiments of the present invention wherein there are shown and described exemplary embodiments of this invention, simply by way of illustration of modes best suited to carry out the communication device with a voice automatic responding function and the automatic responding method thereof according to the exemplary embodiments of the present invention.

### BRIEF DESCRIPTION OF THE DRAWINGS

FIG. 1 is a functional block diagram of a communication device with a voice automatic responding function according to one exemplary embodiment of the present invention.

FIG. 2 is schematic diagram illustrating the fields of the automatic responding data according to one exemplary embodiment of the present invention.

FIG. 3 and FIG. 4 are schematic diagrams illustrating an operation interface of setting automatic responding data according to a first exemplary embodiment of the present invention.

FIG. 5 illustrates a flow chart of setting automatic responding data according to a first exemplary embodiment of the present invention.

FIG. 6 is a schematic diagram illustrating an operation interface of setting automatic responding data according to a second exemplary embodiment of the present invention.

FIG. 7 is a schematic diagram illustrating a data structure of data of options according to an exemplary embodiment of the present invention.

FIG. 8 is a schematic diagram illustrating an operation interface of setting automatic responding data according to a third exemplary embodiment of the present invention.

FIG. 9 illustrates a flow chart of setting automatic responding data according to a third exemplary embodiment of the present invention.

FIGS. 10 to 12 are schematic diagrams illustrating an operation interface of automatic responding service employing the communication device provided by the exemplary embodiment of the present invention.

FIG. 13 illustrates a flow chart of automatic responding service employing the communication device provided by the exemplary embodiment of the present invention.

### DESCRIPTION OF THE EXEMPLARY EMBODIMENTS

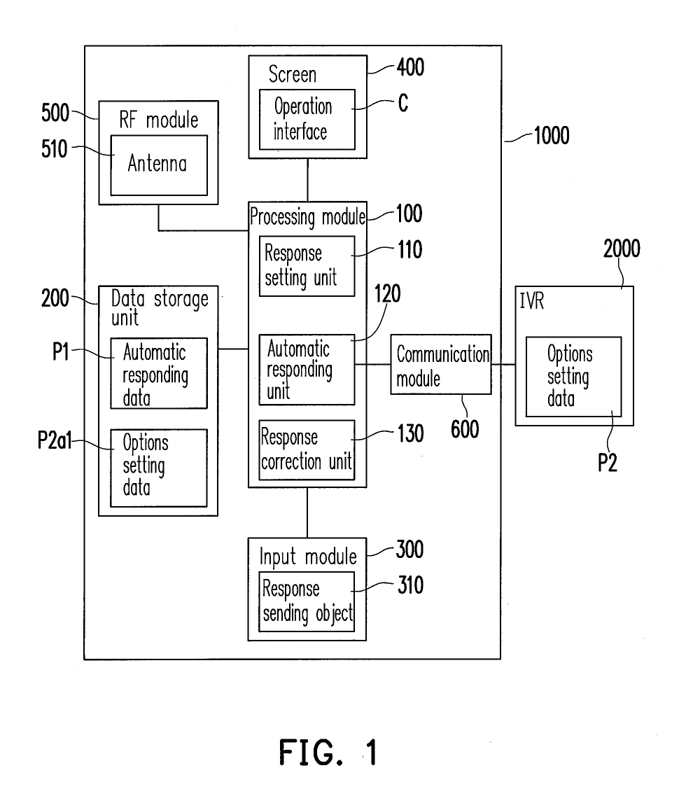

FIG. 1 is a functional block diagram of a communication device with a voice automatic responding function according to one exemplary embodiment of the present invention. The communication device 1000 may be a telephone, a mobile phone, a smart phone, a hand-held communication device, a computer, or a notebook computer. The communication device 1000 can dial a phone number so that the communication device 1000 can be connected to an IVR system 2000 for communication. After the connection between the communication device 1000 and the IVR system 2000 is established, the IVR system 2000 sends voice prompts or response to ask a user to select a desired function. The IVR system 2000 may comprise an automated attendant or a voice response unit to achieve the task for automatically responding the user's selected function and sending the voice prompts.

The communication device 1000 may include a processing module 100, a data storage unit 200, an input module 300, a screen 400, a radio frequency (RF) module 500, and a communication module 600.

The processing module 100 may be formed by a processing chip and associated memories and circuits. The processing module 100 includes a response setting unit 110, an automatic responding unit 120, and a response correction unit 130.

The response setting unit 110 may be implemented as program stored in the processing module 100. In another exemplary embodiment, the program may be stored in the data storage unit 200. The response setting unit 110 is used to set automatic responding data P1 and display an operation interface C on the screen 400.

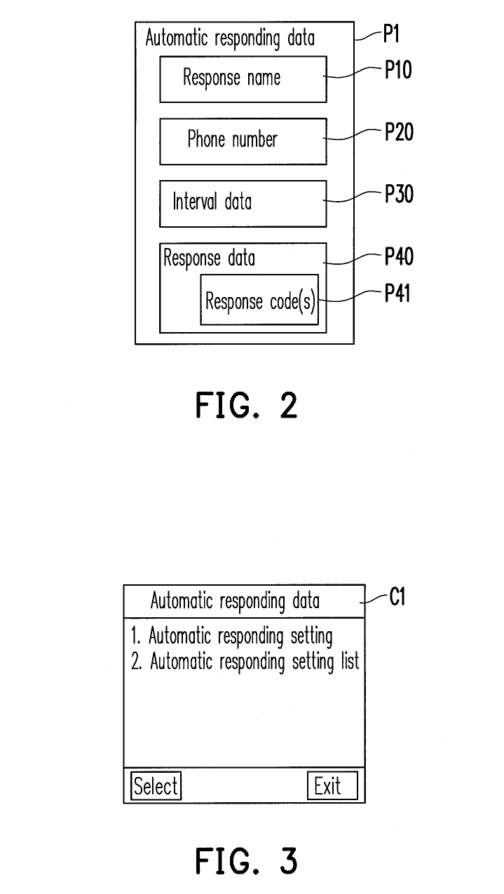

Referring to FIG. 2, the automatic responding data P1 contains a response name P10, a phone number P20, interval data P30, and response data P40. The response name P10 is the name of a respective group of automatic responding data P1. The phone number P20 consists of a plurality of numeral characters. For example, the value “123” represents three numeral characters which may correspond to dual tone multi frequency (DTMF) signals. The response data P40 may contain one or more response codes P41. Each response code P41 may contain one or more numeral and/or symbol characters such as the value “1” and symbols “#” or “*” which may likewise correspond to the DTMF signals. The interval data P30 defines the time interval between dialling the response codes P41. The interval data P30 is a digital code. For example, the value “1” represents the time interval is 1 second.

The automatic responding unit 120 may be implemented as program stored in the processing module 100. In another exemplary embodiment, the program may be stored in the data storage unit 200. The automatic responding unit 120 is used to sequentially dial the phone numbers P20 of the automatic responding data P1 and, after the call is answered, the automatic responding unit 120 is used to respond to the IVR system sever 2000 with the response data P40. If the response data P40 contains a plurality of response codes P41, the automatic responding unit 120 sequentially sends one of the response codes P41 to the IVR system 2000, after the interval indicated by the interval data P30. In another exemplary embodiment, after the call is answered, the automatic responding unit 120 may also respond to the IVR system sever 2000 with the response data P40, after the interval.

The response correction unit 130 may be implemented as program stored in the processing module 100. In another exemplary embodiment, the program may also be stored in the data storage unit 200. The response correction unit 130 is used to correct the automatic responding data P1, for example, correct the phone number P20, the interval data P30, or response data P40.

The data storage unit 200 may be implemented as a memory electrically connected with the processing module 100. The data storage unit 200 is used to storage the automatic responding data P1.

The input module 300 may be electrically connected to the processing module 100. The input module 300 may consist of a plurality of keys or, alternatively, be a sensing device on the screen 400 such that the screen 400 becomes a touch screen.

The input module 300 is used to input the phone number P20, response data P40, and the interval data P30. The input module 300 may include a response sending object 310. The response sending object 310 may be a key. Pressing the response sending object 310 may cause the automatic responding unit 120 to responses the response data P40. If the response data P40 contains a plurality of response codes P41, the response sending object 310 is pressed multiple times to sequentially send at least one of the response codes P41, respectively, after the call is answered.

The screen 400 is electrically connected to the processing module 100. The screen 400 is used to display the automatic responding data P1, operation interface C and/or other relevant information.

The communication device 1000 may be connected to the IVR system 2000 in a wireless communication manner. The RF module 500 is electrically connected to the processing module 100. The RF module 500 may include an antenna 510. When the communication device 100 dials the phone number P20 or sends the response data P40, the communication device 100 may use the RF module 500 to wirelessly communicate with the IVR system 2000.

The communication device 100 may also be connected to the IVR system 2000 in a wired communication manner. The communication module 600 is electrically connected to the processing module 100. When the communication device 100 dials the phone number P20 or sends the response data P40, the communication module 600 may communicate with the WR system 2000 via a signal transmission line such as a network cable or a telephone cable.

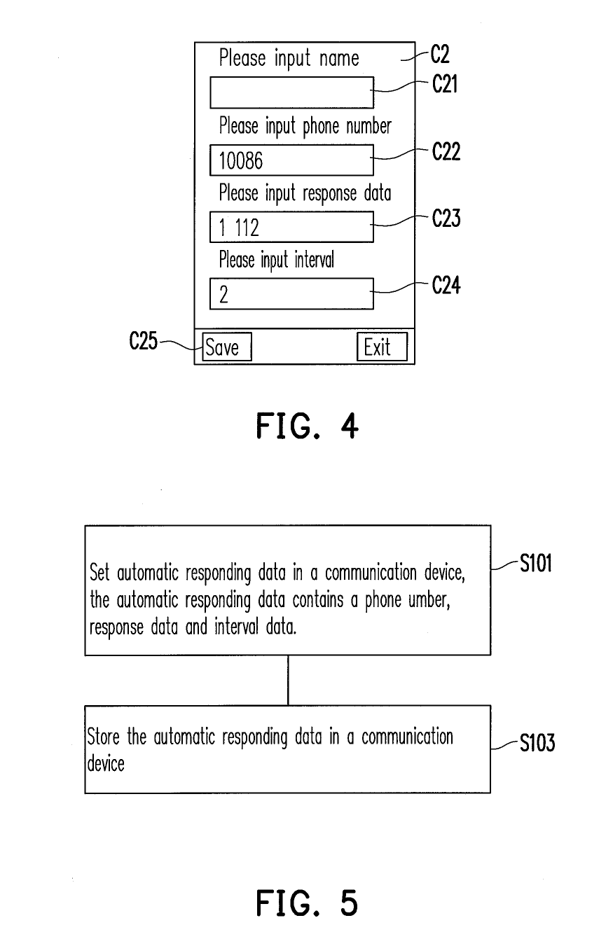

Now referring to FIGS. 3 and 4, an operation interface of setting automatic responding data according to a first exemplary embodiment of the present invention is illustrated, where like references numerals refer to like elements. FIG. 3 illustrates an operation interface C1 displayed on the screen 400. The processing module 100 operates to display the operation interface C1 on the screen 400. The operation interface C1 contains two items allowing the user to select, including Automatic responding setting and Automatic responding setting list. The user may operate the input module 300 or touch the screen 400 with a touch pen to send a selecting command to the processing module 100 to select a desired item displayed on the operation interface C1.

The first item “1. Automatic responding setting” is first selected. As shown in FIG. 4, an operation interface C2 is illustrated, which displays a name input field C21, a phone number input field C22, a response data input field C23, an interval input field C24, and a save object C25. The name input field C21 allows the user to input the response name P10 of the corresponding group of automatic responding data P1. The phone number input field C22 allows the user to input the phone number P20. The response data input field C23 allows the user to input the response data P40. If the response data P40 contains a plurality of response codes P41, a space character may be inserted between adjacent response codes P41 to separate the adjacent response codes P41. Alternatively, each of the plurality of response codes P41 has only one character, and it is set to output only one character signal each time. In this case, no space character is needed. The interval input field C24 allows the user to input a desired time interval. If no interval is inputted or a value “zero” is inputted, a manual responding mode may be activated, as described hereinafter in detail. The save object C25 may be pressed to save the automatic responding data P1 in the data storage unit 200.

The automatic responding data P1 may also be inputted in other manners. For example, the name input field C21 may be first displayed. After the save object C25 is pressed, other fields, such as the phone number input field C22, are displayed till all the data is inputted. With respect to the input of the response data P40, it is also possible to display one operation interface for each response code P41. That is, after one answer number group P41 is inputted, a confirm object (not shown) is pressed and then another response data input field C23 is displayed till all the response codes P41 are inputted. Finally, the save key is pressed for subsequent input or storing the automatic responding data P1. It is noted that the sequence of inputting the information or data described above is for the purposes of illustration only and should not be regarded as limiting. The user may repeat the above input steps to sequentially establish a plurality of pieces of automatic responding data P1.

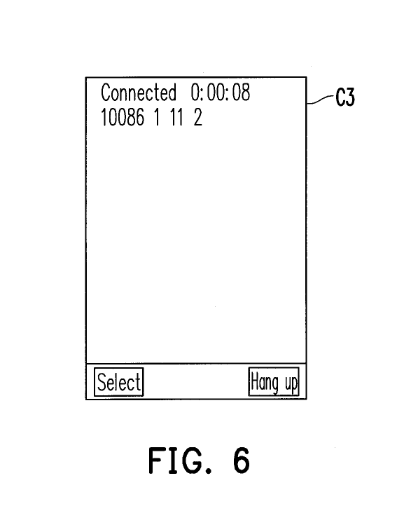

Referring to FIG. 5, a flow chart of setting automatic responding data according to a first exemplary embodiment of the present invention is illustrated, where like reference numerals refer to like elements. In summary, the automatic responding data setting of the present voice automatic responding method includes the following steps. Automatic responding data P1 is set in the communication device 1000, wherein the automatic responding data P1 includes the phone number P20, response data P40, and the interval data P30 (step S101).

The automatic responding data P1 is saved in the communication device 1000 (step S103).

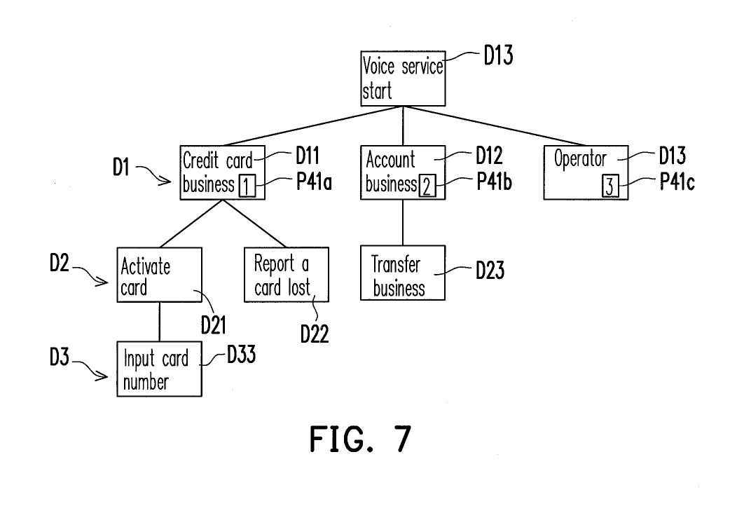

Referring to FIG. 6, an operation interface of setting automatic responding data according to a second exemplary embodiment of the present invention is illustrated. When the user dials the phone number P20 to connect to the IVR system 2000, the phone numbers or symbols inputted by the user are sequentially recorded in the communication device 1000. For example, in the operation interface C3, before the call is answered, the first character group 10086 is set as a phone number P20. The numbers or symbols inputted later at each interval can be set as the response code P41. After the user setting is completed, the user can operate the input module 300 to save the user setting as the automatic responding data P1.

Alternatively, the automatic responding data P1 can be directly downloaded from a website or another device and saved in the communication device 1000.

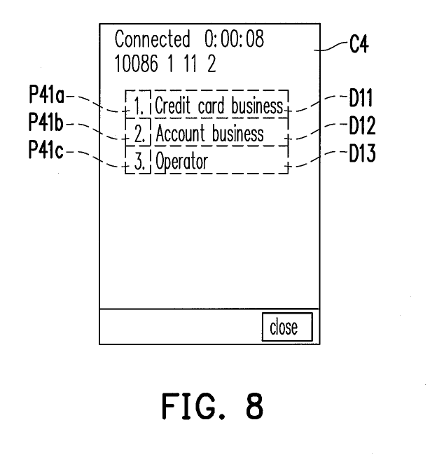

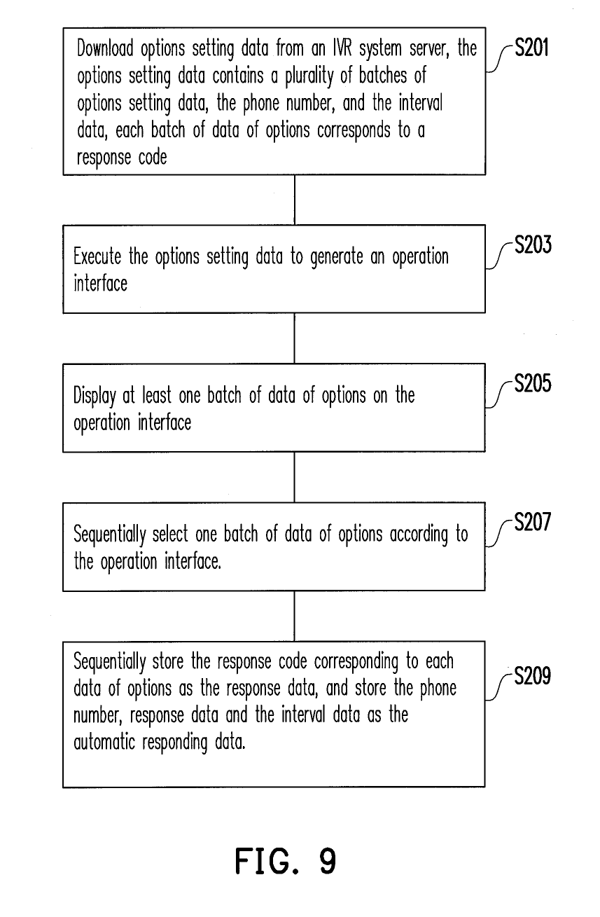

FIG. 7 illustrates a data structure of data of options, and FIG. 8 illustrates an operation interface of setting automatic responding data according to a third embodiment of the present invention, where like reference numerals refer to like elements. Different from the above exemplary embodiments, in the present exemplary embodiment, the communication device 1000 may directly download options setting data P2 via the communication module 600 and save it in the data storage unit 200. The options setting data P2a may contain phone numbers, the interval data, and multiple batches of tree-form selecting data D (see FIG. 7). Each batch of the data of options can be chosen by responding to the IVR system 2000 with a response code.

The structure of the data of options D is illustrated in FIG. 7. The data of options D is set according to the voice response process of the IVR system 2000 and arranged into a plurality of layers. As shown in FIG. 7, the data of options D are divided into a plurality of batches of first layer data of options D1, a plurality of batches of second layer data of options D2, and a plurality of batches of third layer data of options D3. Each batch of first layer data of options D1 has at least one batch of the second layer data of options D2 associated therewith. For example, the first layer data of the option D11 corresponds to two batches of associated second layer data of options D21, D22, the first layer data of the option D12 corresponds to one batch of data of the option D23, and the second layer data of the option D21 corresponds to one batch of third layer data of the option D22. In another case, one batch of data of options does not correspond to a next layer data of options. For example, the first layer data of the option D13 does not have second layer data of options associated therewith, and the second layer data of the option D23 does not have third layer data of options associated therewith.

The user may activate the response setting unit 110 to read the options setting data P2a stored in the data storage unit 200, and an operation interface C is displayed on the screen 400 according to the options setting data P2a. Referring to FIG. 8, the operation interface C4 displays three batches of first layer data of options D11, D12, D13 allowing the user to select. Each batch of first layer data of options D11, D12, D13 corresponds to a corresponding response codes P41a, P41b, P41c (see FIG. 7).

For instance, when the user inputs the value “1” using the input module 300 or alternatively clicks the first layer data of the option D11 on the operation interface C4 using a touch pen (not shown), setting one response code P41a is completed. If the first layer data of options D1 has associated second layer data of options D2, the two batches of the second layer data of options D21, D22 associated with the selected first layer data of the option D11 may then be displayed on the operation interface C4. Therefore, the user may continue to select one between the second layer data of options D21 and D22 to complete the setting of the second response code.

If there is no subsequent data of options for the user to select, for example, if the second layer data of the option D22 does not have associated third layer data of options, the operation interface C4 may display the name input field C21 (see FIG. 4) prompting the user to input the response name. Finally, the response setting unit 110 saves at least one answer number group sequentially set by the user as the response data, and stores the response data, response name and the phone numbers and/or the interval data contained in options setting data P2a as the automatic responding data. The automatic responding data may be stored in the data storage unit 200.

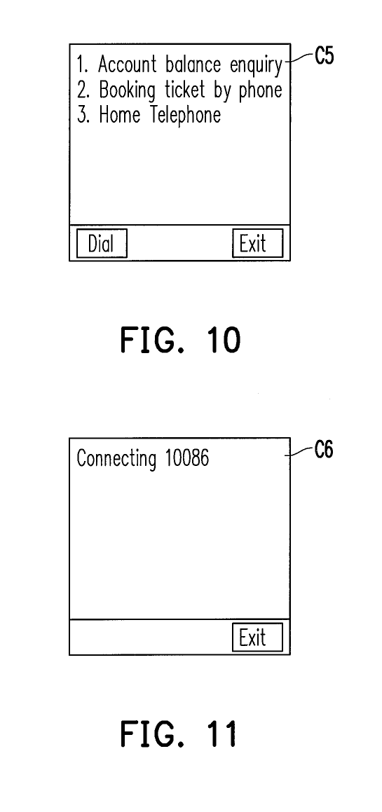

Referring to FIG. 9, a flow chart of setting automatic responding data according to a third exemplary embodiment of the present invention is illustrated, wherein like reference numerals refer to like elements.

Options setting data P2 is downloaded from the IVR system 2000 using the communication module 600 of the communication device 1000. The options setting data contains multiple batches of data of options, phone numbers, and an interval data. Each batch of data of options corresponds to a response code. (step S201).

The options setting data P2 is stored in the data storage unit 200 and an operation interface is generated by executing the options setting data P2 (step S203).

The response setting unit 110 displays an operation interface C on the screen 400, with at least one batch of data of options displayed on the operation interface C (step S205).

The user may touch the operation interface C using a touch pen or operate the input module 300 to generate an option signal to sequentially select a batch of data of options (step S207).

The response code corresponding to the data of options is sequentially stored as response data, and the phone numbers, response data and the interval data are stored as the automatic responding data, thus completing the setting of the automatic responding data (step S209).

In another exemplary embodiment, the setting information P2 may be stored in any server (e.g. a web server) or any storage medium (e.g. optical disc, memory card), may be downloaded using any computer device (e.g. any personal computer, notebook computer) and stored in the computer device. The operation interface may be displayed on the computer device. Finally, after the options setting data is generated, the options setting data is stored in the communication device 1000 to complete the setting of the automatic responding data.

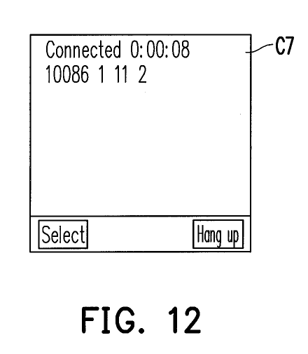

To use the present voice automatic responding function, the user may select the item “2. Automatic responding setting list” shown in FIG. 3. After the item is selected, an operation interface C5 may be displayed as shown in FIG. 10. The operation interface C5 shows a list of response names P10 that correspond to all the automatic responding data P1 stored in the memory. In the present exemplary embodiment, the automatic responding setting list may be an address book of common mobile phones, which lists general phone names (e.g. “home telephone” shown in FIG. 5). The data corresponding to the phone names generally does not have response data P40 and the interval data P30 but only has the phone numbers.

After the user selects the response name P10 at the operation interface C5, the processing module 100 executes the automatic responding unit 120 to dial the phone number P20 in the automatic responding data P1 (as in the operation interface C6 shown in FIG. 11) according to the automatic responding data P1 in the data storage unit 200 that corresponds to the response name P10.

Referring to FIG. 12, after the call is connected, the processing module 100 receives a call-connected signal and then notifies the automatic responding unit 120 to check whether to activate an automatic responding mode or a manual responding mode. In the present exemplary embodiment, if the interval data P30 does not contain the value “0”, the automatic responding mode is then activated such that the automatic responding unit 120 sequentially responds to the IVR system 2000 with the response data P40 after the interval automatically.

Responding with the response data P40 may alternatively be performed in the manual responding mode which is activated if the automatic responding unit 120 detects that the interval data P30 contains on value or the value is “0”. After the call is answered, the response sending object 310 needs to be pressed in order to respond with the response data P40. If the response data P40 has multiple response codes P41, pressing the response sending object 310 once causes the automatic responding unit 120 to send at least one of the multiple response codes P41. However, it is noted that the automatic responding mode or manual responding mode can be determined in a different manner. For example, it is possible to enter or change into the automatic responding mode or manual responding mode by operating the input module to press a particular key before the call is answered.

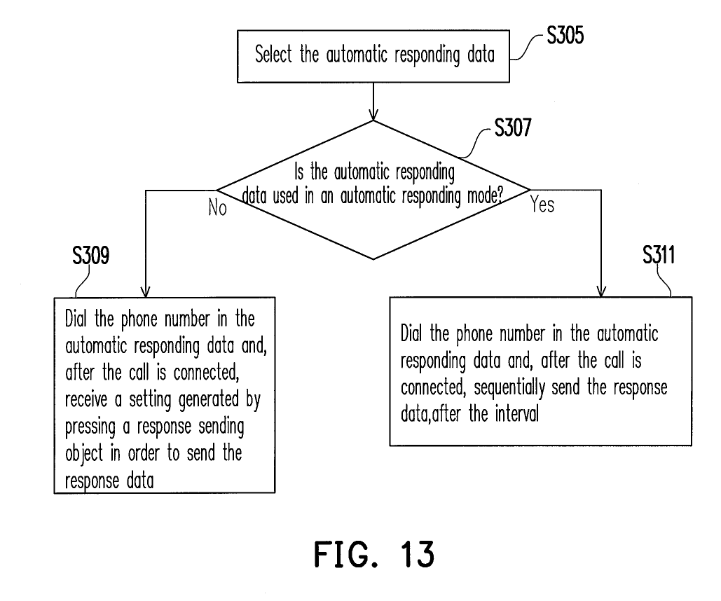

FIG. 13 illustrates a flow chart of the automatic responding service according to one exemplary embodiment of the present invention, where like reference numerals refer to like elements. At step S305, the automatic responding data P1 is selected. At step S307, it is determined whether the automatic responding data P1 is used in a manual responding mode or automatic responding mode.

If the automatic responding data P1 is used in a manual responding mode, the phone number P20 in the automatic responding data P1 is dialled and, after the call is answered, a setting generated by pressing a response sending object 310 is received to send the response data P40. If the response data P40 contains multiple response codes P41, the response sending object 310 is pressed, respectively, to sequentially send the response codes P41. The manual responding mode may be provided for the user to use in situations where, in some special IVR systems 2000, input cannot be performed in the automatic responding mode (step S309).

If the automatic responding data P1 is used in an automatic responding mode, the phone number P20 in the automatic responding data P1 is automatically dialled and, after the call is answered, the response data P40 is sent sequentially, after the interval. If the response data P40 contains multiple response codes P41, the response codes P41 are sent sequentially, after the interval (step S311).

Therefore, by using the present communication device with the voice automatic responding function and the automatic responding method, instead of undergoing the long voice response process, the user can directly reach a desired function, in particular, for example, the bill inquiry or ticket booking function, thereby greatly facilitating the use of the voice service.

The foregoing description of the exemplary embodiments of the present invention has been presented for purposes of illustration and description. It is not intended to be exhaustive or to limit the present invention to the precise form or to exemplary embodiments disclosed. Accordingly, the foregoing description should be regarded as illustrative rather than restrictive. Obviously, many modifications and variations will be apparent to practitioners skilled in this art. The exemplary embodiments are chosen and described in order to best explain the principles of the present invention and its best mode practical application, thereby to enable persons skilled in the art to understand the present invention for various embodiments. It is intended that the scope of the present invention be defined by the claims appended hereto and their equivalents in which all terms are meant in their broadest reasonable sense unless otherwise indicated. Therefore, the term “the invention”, “the present invention” or the like does not necessarily limit the claim scope to a specific exemplary embodiment, and the reference to particularly preferred exemplary embodiments of the present invention does not imply a limitation on the present invention, and no such limitation is to be inferred. The present invention is limited only by the spirit and scope of the appended claims. The abstract of the present disclosure is provided to comply with the rules requiring an abstract, which will allow a searcher to quickly ascertain the subject matter of the disclosure. It is submitted with the understanding that it will not be used to interpret or limit the scope or meaning of the claims. Any advantages and benefits described may not apply to all embodiments of the present invention. It should be appreciated that variations may be made in the exemplary embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An automatic responding method for responding to an interactive voice response (IVR) system, the method comprising:
setting automatic responding data including a phone number, response data, and interval data;
storing the automatic responding data in the communication device;
selecting the automatic responding data; and
calling by dialling the phone number in the automatic responding data and, after the call is answered by an IVR system, responding to the IVR system with the response data after an interval indicated by the interval data.

2. The automatic responding method according to claim 1, wherein the step of setting the automatic responding data is performed on the communication device.

3. The automatic responding method according to claim 1, wherein the step of setting the automatic responding data comprises:
downloading options setting data including data of options offered by the IVR system, the phone number, and the interval data, wherein each of the options can be chosen by responding to the IVR system with a response code;
forming an operation interface;
displaying at least one of the options on the operation interface; and
storing the response code corresponding to chosen one of the options as the response data, and storing the phone number, the response data and the interval data as the automatic responding data.

4. The automatic responding method according to claim 1, wherein the step of setting the automatic responding data comprises:
at an operation interface, sequentially choosing at least one of options offered by the IVR system, wherein the at least one option can be chosen by responding to the IVR system with a response code; and
sequentially storing the response code corresponding to chosen one of the options as the response data, and storing the phone number, the response data, and the interval data as the automatic responding data.

5. The automatic responding method according to claim 4, wherein at least one of the response code is inputted at the operation interface.

6. The automatic responding method according to claim 1, after the step of selecting the automatic responding data, further comprising a step of determining whether the automatic responding data is to be used in a manual responding mode or an automatic responding mode.

7. The automatic responding method according to claim 6, wherein if it's determined that the automatic responding data is to be used in a manual responding mode, the step of responding to the IVR system with the response data is performed after pressing a response sending object.

8. The automatic responding method according to claim 7, wherein the response data include response codes, the IVR system offers options each of which can be chosen by responding to the IVR system with one of the response codes, and the step of responding to the IVR system with the response data comprises sequentially sending each of the response codes after pressing the response sending object.

9. A communication device with an automatic responding function, for responding to an interactive voice response (IVR) system, the communication device comprising:
a response setting unit for setting automatic responding data, wherein the automatic responding data include a phone number, interval data indicating an interval, and response data;
a data storage unit for storing the automatic responding data; and
an automatic responding unit for calling by dialling the phone number in the automatic responding data and, after the call is answered by an IVR system, for responding to the IVR system with the response data after the interval.

10. The communication device with the automatic responding function according to claim 9, further comprising a display for displaying an operation interface allowing a user to sequentially choose at least one of options offered by the IVR system, wherein the at least one option can be chosen by responding to the IVR system with a response code.

11. The communication device with the automatic responding function according to claim 10, wherein the response setting unit sequentially stores the response code corresponding to chosen one of the options as the response data.

12. The communication device with the automatic responding function according to claim 9, wherein the data storage unit is further used to store options setting data including data of options offered by the IVR system, the phone number, and the interval data.

13. The communication device with the automatic responding function according to claim 12, wherein the options setting data is downloaded from the IVR system.

14. The communication device with the automatic responding function according to claim 9, wherein the response data include response codes, and after the call is answered by the IVR system, the automatic responding unit is used to sequentially send each of the response codes after the interval.

15. The communication device with the automatic responding function according to claim 9, further comprising a response sending object, wherein pressing the response sending object causes the automatic responding unit to respond to the IVR system with the response data.

16. The communication device with the automatic responding function according to claim 15, wherein the response data include response codes, and after the call is answered by the IVR system, the function of responding to the IVR system with the response data comprises sequentially sending each of the response codes after pressing the response sending object.

17. The communication device with the automatic responding function according to claim 9, further comprising a response correction unit for correcting the automatic responding data.

18. The communication device with the automatic responding function according to claim 9, further comprising an input module used to input the phone number, the response data and the interval.

19. The communication device with the automatic responding function according to claim 9, further comprising an RF module, wherein the automatic responding unit is used to dial the phone number and respond to the IVR system through wireless communication between the RF module and the IVR system.

20. The communication device with the automatic responding function according to claim 9, further comprising a communication module, wherein the automatic responding unit is used to dial the phone number and respond to the IVR system by the automatic responding unit communicating with the IVR system over a signal transmission line.
